(19) United States
(12) Patent Application Publication
(10) Pub. No.: US 2024/0003159 A1
(43) Pub. Date: Jan. 4, 2024

(54) FOUNDATION FOR A WIND TURBINE

(71) Applicant: ANKER WERK I PORT MUKRAN GMBH, Sassnitz (DE)

(72) Inventors: Gregor Prass, Hamburg (DE); Christoph Schriefer, Redefin (DE)

(21) Appl. No.: 18/028,680

(22) PCT Filed: Sep. 29, 2021
(86) PCT No.: PCT/EP2021/076890

§ 371 Date: Mar. 27, 2023

(30) Foreign Application Priority Data
Sep. 29, 2020 (DE) 10 2020 125 441.5
Oct. 4, 2020 (DE) 10 2020 125 918.2

(51) Int. Cl. E04H 12/22; E02D 27/42

(52) U.S. Cl. CPC E04H 12/2238; E02D 27/425; E02D 2600/40; E02D 2200/1685; E02D 2200/165

(57) ABSTRACT

The invention relates to an anchor cage for a foundation of a wind turbine with at least one lower abutment, with at least one upper abutment, with at least one vertical connecting element between the at least one lower abutment and the at least one upper abutment, with at least one element for introducing a prestress into the at least one vertical connecting element. It is provided that the at least one lower abutment and/or the at least one upper abutment is formed by at least two abutment segments arranged one above the other, and that at least one of the two abutment segments is composed of at least two abutment elements.

The invention relates to an anchor cage for a foundation of a wind turbine with at least one lower abutment, with at least one upper abutment, with at least one vertical connecting element between the at least one lower abutment and the at least one upper abutment, with at least one element for introducing a prestress into the at least one vertical connecting element, as well as a foundation for a wind turbine with such an anchor cage, wherein the foundation comprises substantially prefabricated elements, preferably of reinforced concrete, with a first, vertically extending base-like section on which a tower of the wind turbine can be arranged, and a second, substantially horizontally extending section as foundation body, which is in contact with the ground, wherein the first section is arranged above the second section.

Foundations for wind turbines are essentially constructed as in-situ concrete foundations. For this purpose, a pit is excavated at the erection site, which is then provided with a clean layer. The formwork and reinforcement are then erected and the whole is filled with concrete on site. In this process, a flat body is erected, if necessary with a base, see for example US 20160369520 A1 or WO 2008/036934 A2.

Furthermore, the foundations are provided with connecting means by which a tower of the wind turbine is connected to the foundation. Different constructions are provided for this purpose. For example, anchor rods are provided in the foundation against which a tower flange is bolted. These anchor rods can be provided in holes in the foundation or cast directly into the concrete. If necessary, they are bolted against an abutment at the bottom. An abutment may also be provided at the top to hold the anchor rods in a desired arrangement, if necessary. Such arrangements are also called anchor cages.

US 20160369520 A1 or WO 2008/036934 A2 include a prefabricated anchor cage to allow connection to the wind turbine tower.

In addition to the transport effort involved in supplying the concrete, formwork, anchor cage, and reinforcement, this is very labor-intensive on site. Quality assurance is also costly and, depending on the weather, also problematic. Furthermore, the dismantling after the end of the service life of the wind turbine is expensive and very time-consuming. This applies in particular to concrete towers for wind turbines, which ideally have a diameter to height ratio of approx. 1:10, so that diameters of 8 to 15 m are not uncommon. Foundations for such towers have so far been made in cast-in-place concrete. Furthermore, areas must be provided where the prestressing elements of the tower can be attached to the foundation and prestressed. The prestressing is carried out with devices provided for this purpose, which have to be brought into the prestressing areas. As abutments for prestressing or for attaching the prestressing elements (strands/cables), elaborate cantilever structures are usually provided inside the foundation, under which the devices are then brought. These structures are costly and in need of improvement.

Furthermore, there is in principle a need to construct wind turbine foundations from prefabricated elements, which would reduce or eliminate the aforementioned problems. In principle, the advantage of prefabrication is that the components can be produced in a standardized manner under defined conditions. It also reduces the amount of work required on site. Various approaches to this have been described in the state of the art.

For example, WO 2008/036934 A2 shows a combination of precast elements and classic formwork/reinforcement construction. This reduces the previously mentioned disadvantages only insignificantly.

Other approaches for making foundations for wind turbines from prefabricated components are shown in the prior art as follows:

EP 1 058 787 B1 discloses a foundation for a wind turbine for erecting offshore wind turbines that are transported completely pre-assembled—i.e. including the foundation—and set down in one piece on the seabed at the erection site. The foundation has individual prefabricated segments. These can be made of concrete. A planar section and a base section are disclosed. The base section consists of circular rings. The planar section consists of individual base elements that are trapezoidal in base area, on which the base section is vertically mounted at the inner end, which has vertical passages. The flat base sections are connected to each other by means of tongue and groove joints. The base section and the flat base section are connected by a diagonal brace for bracing. The circular segments of the base section also have vertical passages. Connecting cables/anchor rods are inserted into the passages. If the foundation sections are to be made of concrete, a flat steel abutment ring is provided below the base elements in the area of the vertical passages. The connecting cables/anchor rods are used to mount the foundation like an anchor basket and to fasten the wind turbine to the foundation. In addition, horizontal passages are provided in base elements and diagonal struts, in which connecting cables/anchor rods are also arranged, with which the elements of the foundation are horizontally prestressed. Only through the horizontal prestressing is the foundation completed in such a way that it can bear loads. Thus, EP 1 058 787 B1 discloses a foundation consisting of individual prefabricated concrete elements, with a surface section and a base section, whereby at least these two sections are connected to each other vertically and horizontally.

The disadvantage here is that considerable costs and labor are required for connecting the elements and producing the statically resilient foundation.

EP 1 074 663 A1 discloses a foundation for a wind turbine with a central body as a base with laterally extending star-shaped ribs/projections/beams bolted to it. Ribs and central body are horizontally bolted together on site. The parts are prefabricated from concrete, among other materials, and are delivered to the construction site by truck, arranged by crane and connected to each other horizontally on site via flanges and bolted connections. Furthermore, anchors are required on the outside of the ribs to ensure sufficient load transfer.

The disadvantage here is that here, too, considerable costs and labor are required for connecting the elements and producing the statically resilient foundation. Furthermore, additional anchors are necessary.

WO 2004/101898 A2 discloses a foundation for a wind turbine made of prefabricated concrete components, whereby either a central body is provided to which surface bodies are horizontally bolted, or the foundation consists exclusively of components having both a surface section and a base-like section, which are then horizontally connected to each other by bolting against flanges.

The disadvantage here is that here, too, considerable costs and labor are required for connecting the elements and producing the statically resilient foundation. EP 2 182 201 A1 discloses two different foundations for a wind turbine. In both, a foundation is erected from prefabricated concrete components after appropriate delivery on site. Both contain a flat section and a base-like section. In Variant 1, a central body is provided. The ribs/area elements are attached to this. When assembled, the ribs form a polygonal body. The central body has a projection which is embraced by a corresponding recess on the ribs. The ribs are additionally locked against the central body by means of a lashing ring. Anchor rods are provided on the surface headers for mounting the tower. In the second variant, the ribs have horizontally projecting anchor elements which, when assembled, extend radially into the center of the foundation. Plates are provided below and above the anchors. In-situ concrete is placed in the cavity thus formed to connect the anchors and form a central body. In both variants, horizontal connection is simplified. However, both the ribs and the central body have dimensions and masses that make transportation complicated. Connecting to the tower is done by vertical tie rods.

WO 2017/141095 A1 and WO 2017/141098 A1 also disclose a foundation for a wind turbine. This foundation is formed from prefabricated rib bodies, which have a base section at their inner end, on which the tower of the wind turbine is arranged. The ribs extend radially outward. In another embodiment, the sections between the ribs are filled with plate elements bolted against the ribs with flanges to form a plate. Centrally, instead of a central body, a steel sleeve is provided, which is connected to reinforcements provided inside the ribs and reinforcing beams provided in internal cavities. The ribs have a base plate. On which a diagonal reinforcing member and the base section are integrally arranged. The base sections are horizontally connected to each other via tongue and groove elements. Furthermore, the base sections have horizontal openings in which clamping elements are provided for horizontally connecting the base sections. Furthermore, anchor rods for connecting the tower to the foundation are cast in the base sections. Furthermore, external ground anchors are also disclosed. The connection to the tower is made by cast-in vertical anchor rods.

The disadvantage here is that here, too, considerable costs and labor are required for connecting the elements and producing the statically resilient foundation.

WO 2019/115622 A1 and WO 2019/201714 A2 disclose first successful foundations for wind turbines made of precast concrete elements for a steel tower and for a concrete tower for a wind turbine. The foundations have two sections. Rib elements are provided, which have a central section on which a base section is provided. The tower of the wind turbine is then arranged on the base section. The base section consists of individual segments which are connected to each other. By means of tendons provided in openings in the central section and in the elements of the base section, the rib elements and the base elements are braced together. Further developments of these foundations have resulted in surprising and particularly efficient improvements in the area of the base. These tendons form a kind of anchor cage.

The objective of the invention is therefore to further improve the aforementioned foundations and to make them economically erectable or erectable from prefabricated elements.

According to the invention, the objective is solved in that the at least one lower abutment and/or the at least one upper abutment is formed from at least two abutment segments arranged one above the other, and in that at least one of the two abutment segments is composed of at least two abutment elements.

This makes it easy to provide an anchor cage with which elements of the foundation can be braced. Furthermore, it is possible to transport the anchor cage to the construction site of the foundation. In addition, it has been surprisingly shown that the structure of the anchor cage is capable of absorbing tensile and compressive forces of the wind turbine acting on the foundation, which means that the anchor cage can be taken into account statically and dynamically in the design of the foundation.

A further teaching of the invention provides that the at least one upper and/or the at least one lower abutment are of closed annular shape, preferably as a circular ring or as a polygon.

A further teaching of the invention provides that the at least two abutment elements are arranged butted, preferably on one plane. This makes it possible to divide the abutment into several parts so that they are particularly easy to transport and at the same time easy to erect on the construction site.

Another teaching of the invention provides that joints are provided between the abuttingly arranged abutment elements.

A further teaching of the invention provides that at least two abutment segments arranged one above the other are each formed from at least two abutment elements. It is advantageous that more than two, preferably 5 to 6, abutment elements are arranged one above the other. The more layers are provided, the lower the loss of load support compared with a one-piece abutment. The loss is approximately 1/n, where n is the number of layers.

According to a further teaching of the invention, the at least two abutment segments arranged one above the other are arranged such that the joints are arranged not to overlap. In this way, the performance of the abutment can be increased in a simple manner.

According to a further teaching of the invention, the abutment elements comprise at least one aperture in which the at least one vertical connecting element is provided.

According to a further teaching of the invention, the vertical connecting means is a tensioning element, preferably an anchor rod particularly preferably with at least one nut for applying the pretension.

According to a further teaching of the invention, one of the abutment elements is a flanged plate.

According to a further teaching of the invention, the lower and/or the upper abutment is formed by at least two concentrically arranged abutments.

According to another teaching of the invention, the at least one upper abutment is a flange of the tower of the wind turbine.

According to another teaching of the invention, a foundation for a wind turbine in any of the embodiments described below includes an anchor cage described previously.

Such a foundation is a foundation for a wind turbine, wherein the foundation comprises substantially prefabricated elements, preferably of reinforced concrete, with a first, vertically extending base-like section on which a tower of the wind turbine can be arranged, and a second, substantially horizontally extending section as foundation body which is in contact with the ground, wherein the first section is arranged above the second section. The foundation is provided in such a way that the first, vertically extending base-like section is formed from at least three layers arranged one above the other, of which the upper and lower layers are formed from at least two ring-like layers and the middle layer is formed from at least one ring-like layer, in that the height of the upper and/or lower layer is less than the height of the middle layer, and in that the layers are vertically braced to the second section by means of at least two vertical tendons.

Such foundations are suitable for both concrete towers and steel towers. The advantage of this foundation is that it does not require any horizontal fasteners at all, while providing sufficient stability even in extreme load situations. Surprisingly, this is achieved in particular by the upper and lower layers comprising of at least two ring-like layers in conjunction with bracing by prestressed tendons.

Alternatively, such a foundation is a foundation for a wind turbine, the foundation comprising substantially prefabricated elements, preferably of reinforced concrete, with a first vertically extending base-like section on which a tower of the wind turbine is arrangeable, with a second substantially horizontally extending section as foundation body, which is in contact with the ground, which has at least two horizontal elements with at least one support section at its inner end, the first section being arranged above the least two support sections of the second section, and with a third section which is arranged below the least two support sections of the second section. The foundation is provided in such a way that a base is provided, which is formed at least from the first, vertically extending base-like section, from the at least two support sections of the second section and from the third, vertically extending base-like section, in that the three sections thereby form at least three layers arranged one above the other, of which the upper and lower layers are formed from at least two ring-like layers and the middle layer is formed from at least one ring-like layer, in that the height of the upper and/or lower layer is smaller than the height of the middle layer, and in that the layers are vertically braced to the second section by means of at least two vertical tendons.

Such foundations are also suitable for both concrete towers and steel towers. The advantage is that this foundation does not require any horizontal fasteners at all, while providing sufficient stability even in extreme load situations. Surprisingly, this is achieved in particular by the upper and lower layers comprising of at least two ring-like layers in conjunction with bracing by prestressed tendons.

These foundations preferably provide for the height, for example H+I, 2×I and/or 2×J, of the upper and lower layers to be less in total than the height of the middle layer. Surprisingly, this allows for an optimum load distribution to be achieved in the foundation.

It is further advantageous that at least one of the layers comprises of at least one prefabricated element, preferably of reinforced concrete. Alternatively, it is provided that at least one of the layers comprises of at least two precast elements, preferably of reinforced concrete. Further alternatively, it is provided that at least two adjacent layers comprise of at least two prefabricated elements, preferably of reinforced concrete. This facilitates the standardized erection of the foundation and reduces the necessary number of transports to the construction site, in particular of in-situ concrete.

It is advantageous that the at least two elements are arranged butted and form the ring-like layer without horizontal fasteners in the vertical joints between the at least two elements. It is advantageous that the vertical joints are provided stress-free and/or that the at least two elements are arranged contact-free in the vertical joints. This in turn facilitates the standardized erection of the foundation and at the same time keeps costs low, because the prefabricated components in the area of the vertical butt joints, for example at distances of up to 3 cm, can be worked with tolerances customary in concrete construction during manufacture. Surprisingly, it has also been shown that such an arrangement provides sufficient stability in the foundation even in extreme load situations.

Another advantage is that the joints or vertical joints of two layers lying directly one above the other are not aligned. Surprisingly, it has been shown that it is possible to break down the individual ring-type layers into individual elements and at the same time achieve sufficient stability even in extreme load situations in the foundation.

It is further advantageous that the prefabricated elements of the first and/or second section are arranged connected to each other substantially without horizontal connecting means, preferably with vertical spacing between the prefabricated elements.

It is also advantageous that the prefabricated elements of the lower and/or upper layer have an increased reinforcement in the normal direction (tensile/compressive reinforcement) and/or that the prefabricated elements of the middle layer have at least one increased reinforcement for dissipating shear loads, in particular in the radial direction The provision of the reinforcements in the manner described above enables the foundation to be constructed cost-effectively.

It is further advantageous that at least one horizontal joint between the prefabricated elements of the first and/or second section are arranged on top of each other free of in-situ concrete and/or mortar. It has been shown that the provision of horizontal contact of the precast elements with sufficiently accurate manufacturing (small tolerances in the horizontal direction of the precast elements) causes sufficient friction in the horizontal joints due to the prestressing, so that sufficient stability is provided in the foundation even in extreme load situations.

It is further advantageous that the prestressing by the at least two tendons is designed in such a way that all horizontal joints between the layers are under pressure in any operating condition and in any extreme load condition of the wind turbine. In this way, sufficient friction of the prefabricated elements is effected in a particularly simple manner, especially in the horizontal joints between the prefabricated elements, so that the foundation provides sufficient stability to the horizontal joints even in extreme load situations, even without material-locking connections.

It is also advantageous that at least two ring-like abutments, preferably in the form of at least one abutment ring, are provided against which the tendons act, at least one abutment being arranged on the upper side of the first section and at least one abutment on the underside of the second or third section. This provides in a simple manner the necessary load abutment for the tendons and the prestressing introduced thereabove. It is advantageous that at least one abutment and/or at least one abutment ring comprises of at least two prefabricated elements which are arranged in abutment with the ring-like abutment and/or abutment ring. This facilitates the transport of the prefabricated elements. Furthermore, it is advantageous that at least one abutment has at least two layers arranged one above the other. This makes it possible to erect the foundation in a standardized manner as a function of the applied prestressing. It is also advantageous that the layers each have at least two elements that are arranged butted, with the butts of two layers lying directly above one another not being arranged in alignment. This avoids time-consuming welding work on site and reduces the construction time of the foundation. Furthermore, it becomes possible in a simple way to adequately transfer the loads of the prestressing via the abutment constructed in this way depending on the foundation design.

It is also advantageous that the second section is formed from at least three horizontal elements, and that the horizontal elements can be arranged as a function of the parameters of the tower to be erected, in particular the tower radius. It is advantageous that the horizontal elements are arranged laterally spaced apart from one another, or that the horizontal elements are arranged laterally parallel spaced apart from one another. This makes it possible in a particularly simple manner to provide a foundation depending on the dimensions of the tower to be erected. In particular, it is possible to create foundations for different tower radii with one type of horizontal element by shifting the horizontal elements in parallel accordingly.

It is also advantageous that the elements of the at least three layers of the first section have at least two essentially vertical apertures, in each of which a tension member, preferably a threaded rod or an anchor bolt with counter elements, is arranged. This makes it possible to provide the foundation quickly and cost-effectively in a particularly simple manner. When providing the openings, precise work with only minor deviations is necessary so that the tendons can be used and, at the same time, to effect the mountability of the prefabricated elements. This is facilitated in particular by the vertical spacing of the elements in a particularly simple manner.

In the following, the invention is explained in more detail by means of embodiment examples in connection with a drawing. Thereby show:

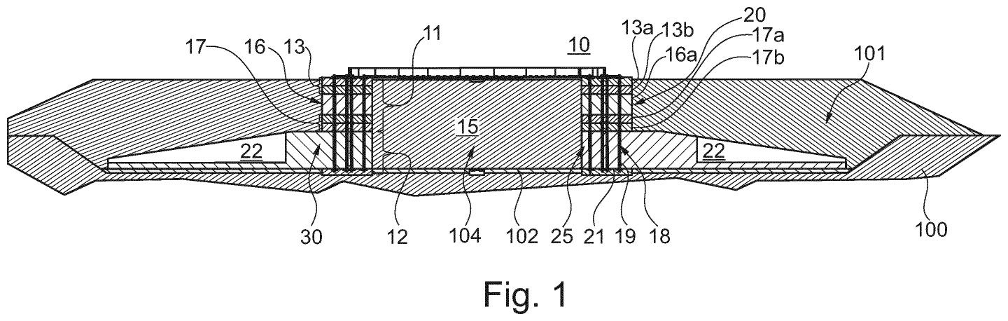

FIG. 1 a sectional view of a first embodiment of a foundation with a first embodiment of an anchor cage according to the invention,

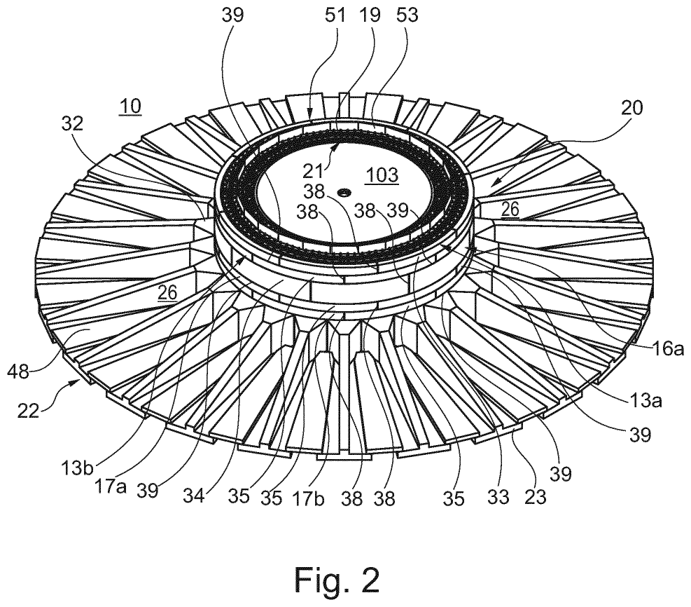

FIG. 2 a spatial view of FIG. 1,

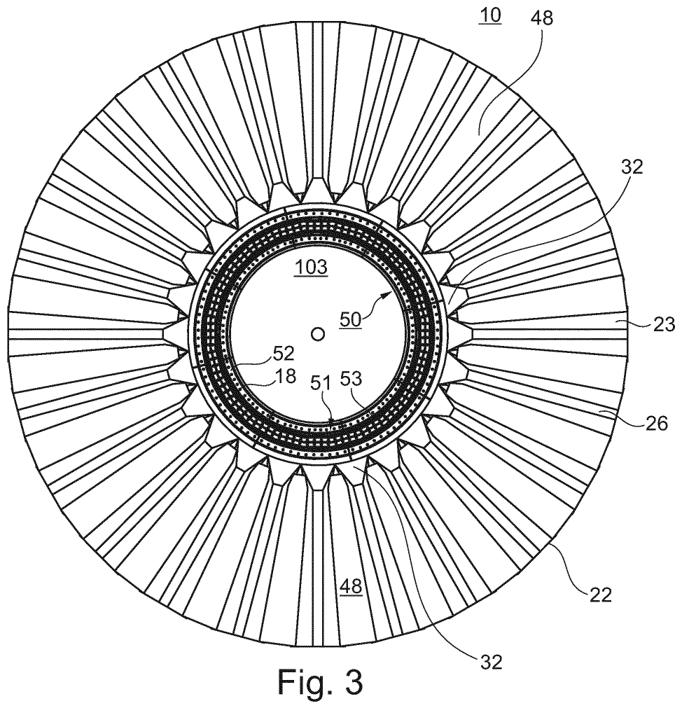

FIG. 3 a top view of FIG. 1,

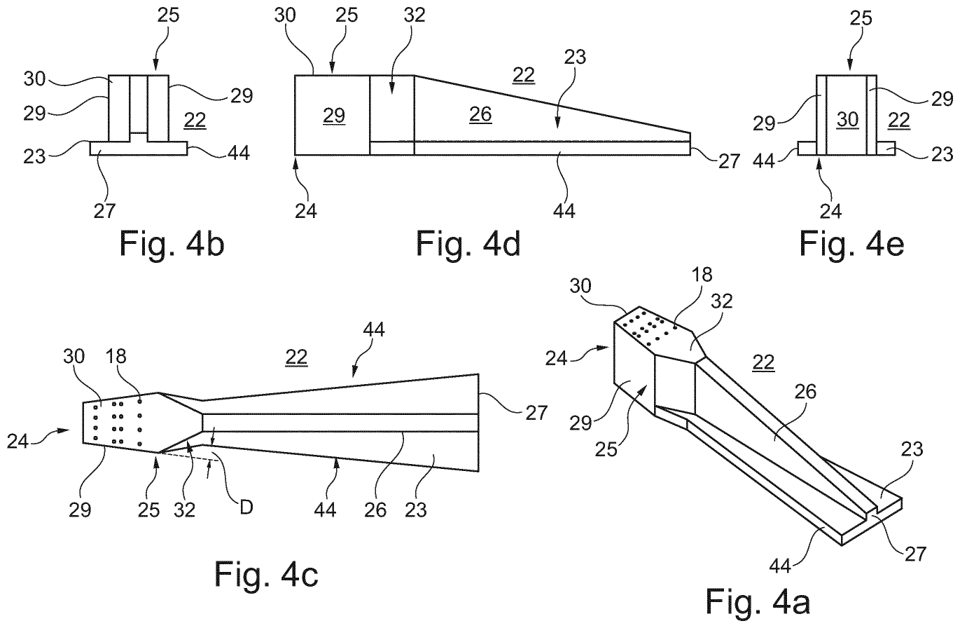

FIGS. 4a to 4e views of a horizontal element,

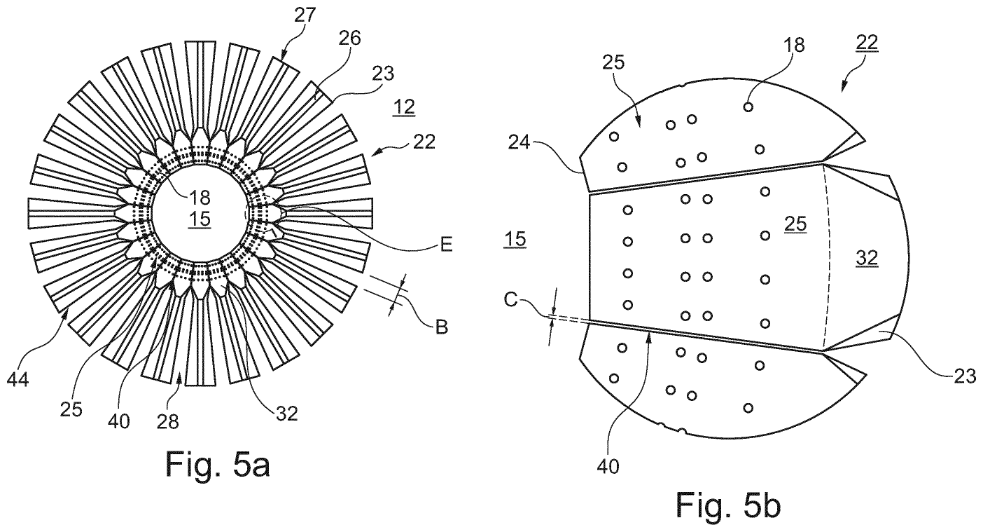

FIG. 5a a plan view of arranged surface elements of the foundation,

FIG. 5b a detailed view of FIG. 5a,

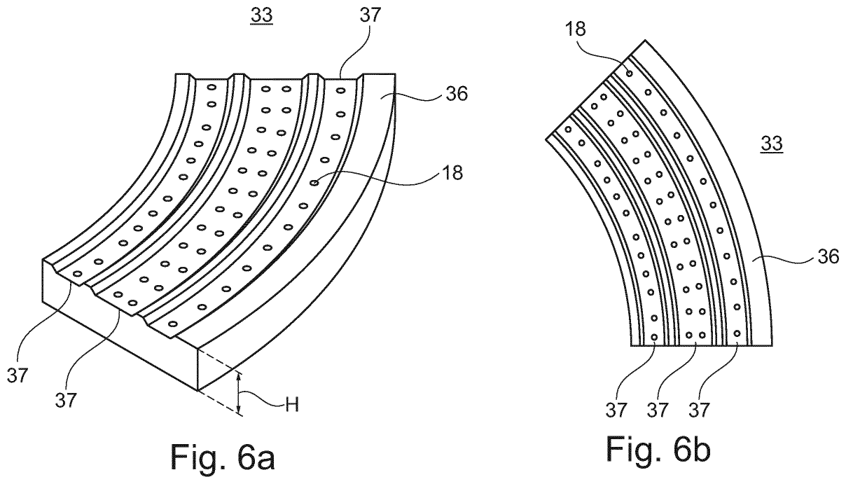

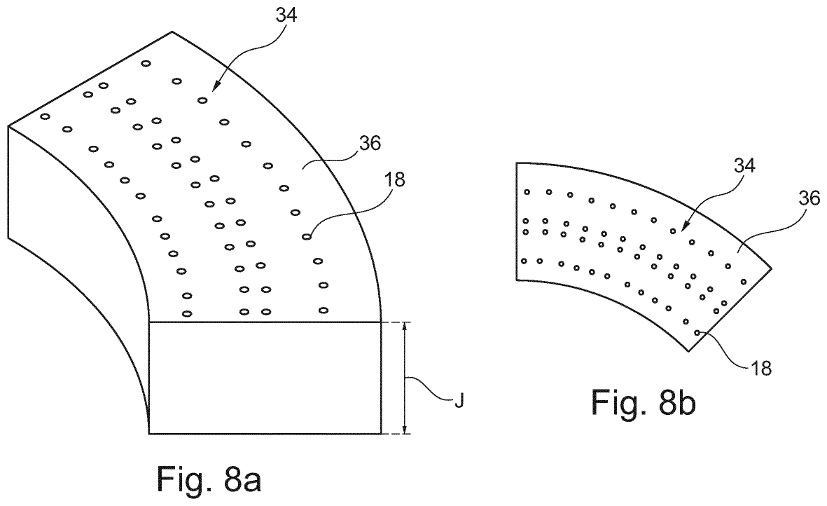

FIGS. 6a to 8b views of base segments in plan and as a spatial view,

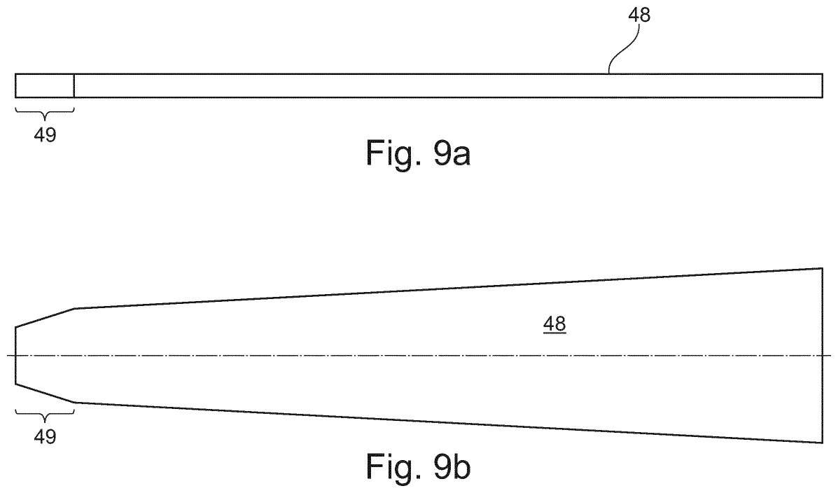

FIG. 9a, 9b a top view and a side view of a cover plate, and

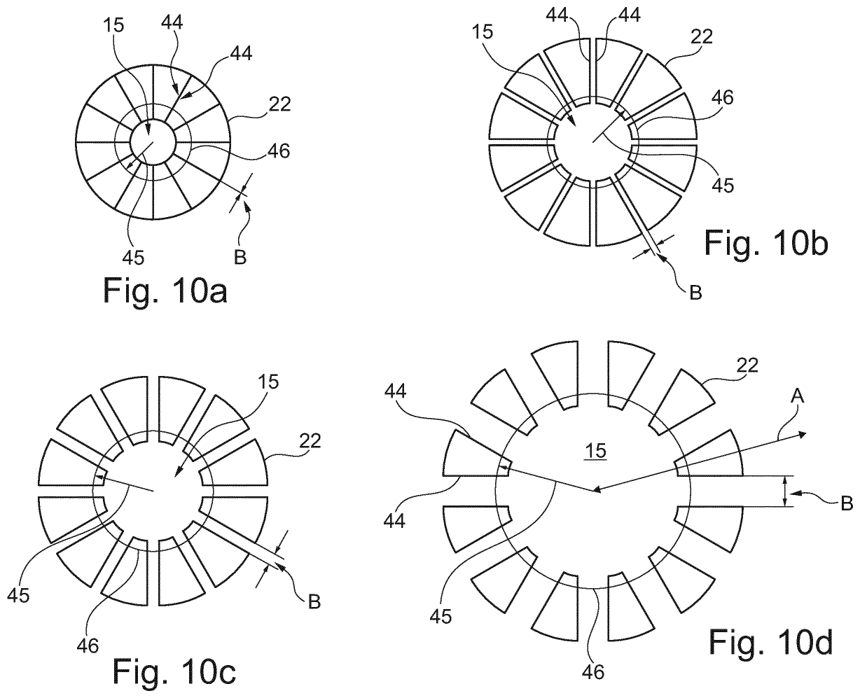

FIGS. 10a to 10d different arrangement possibilities to FIG. 5a.

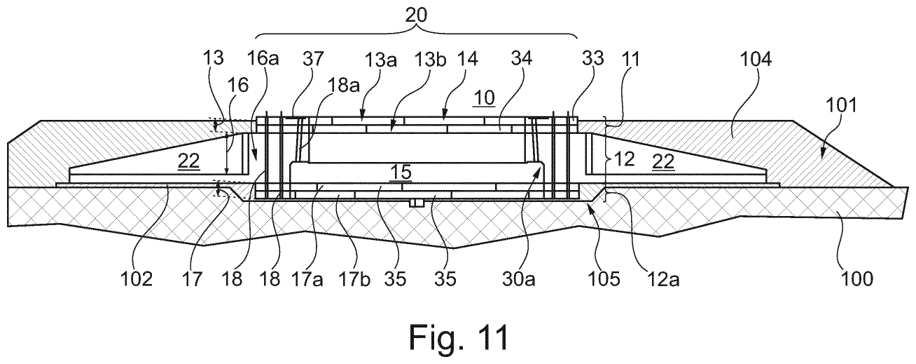

FIG. 11 a sectional view of a second embodiment of a foundation with a second embodiment of an anchor cage according to the invention,

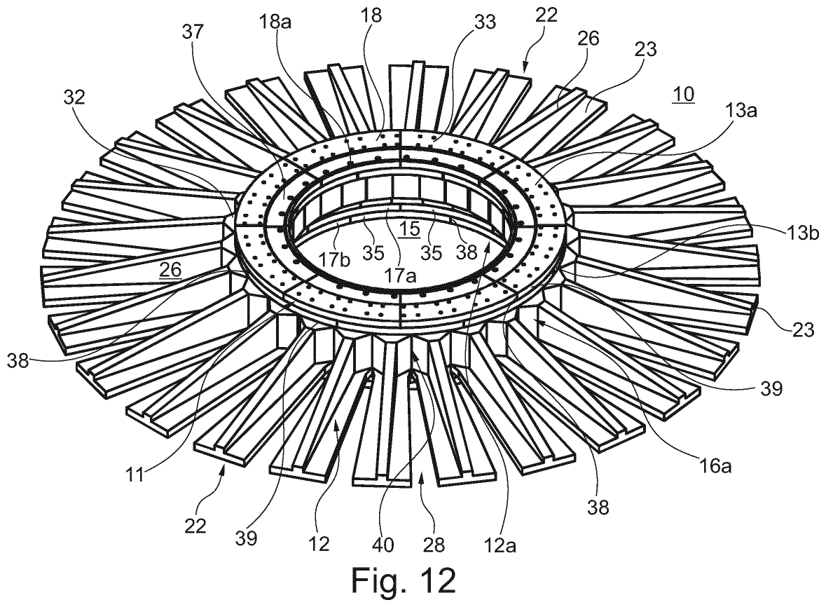

FIG. 12 a spatial view of FIG. 11,

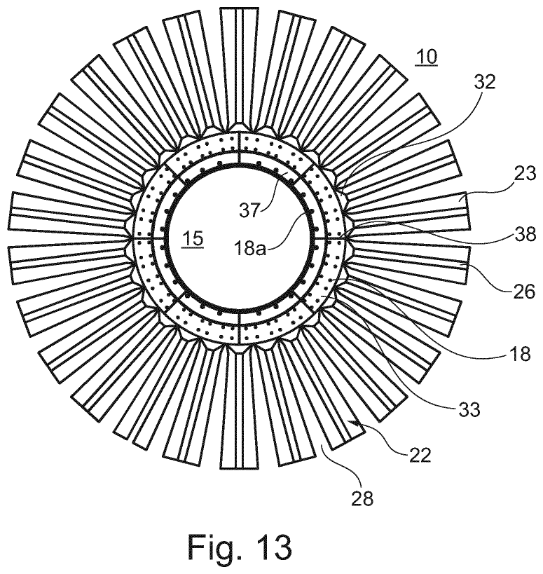

FIG. 13 a top view of FIG. 11,

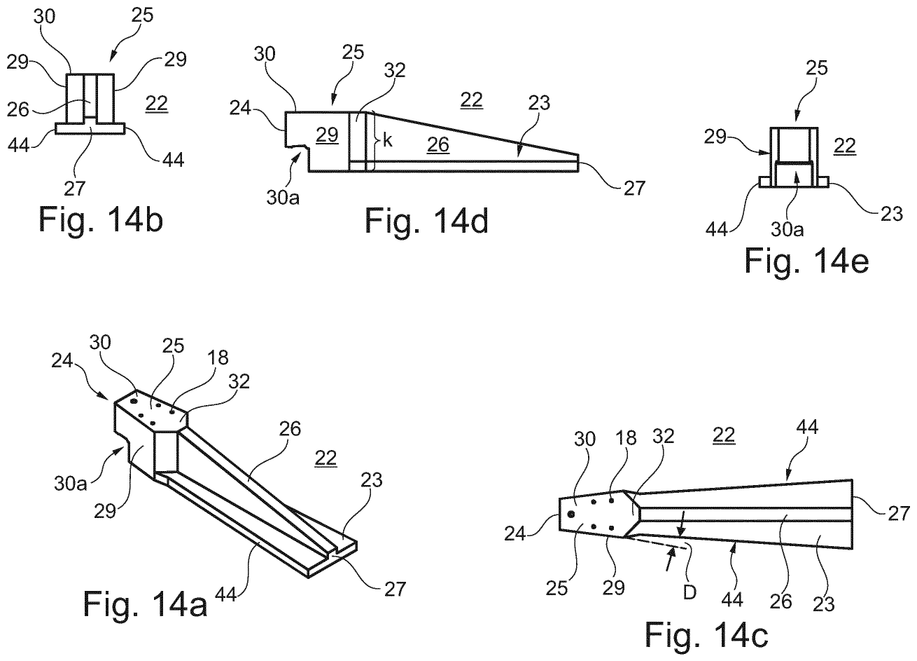

FIGS. 14a to 14e views of a horizontal element,

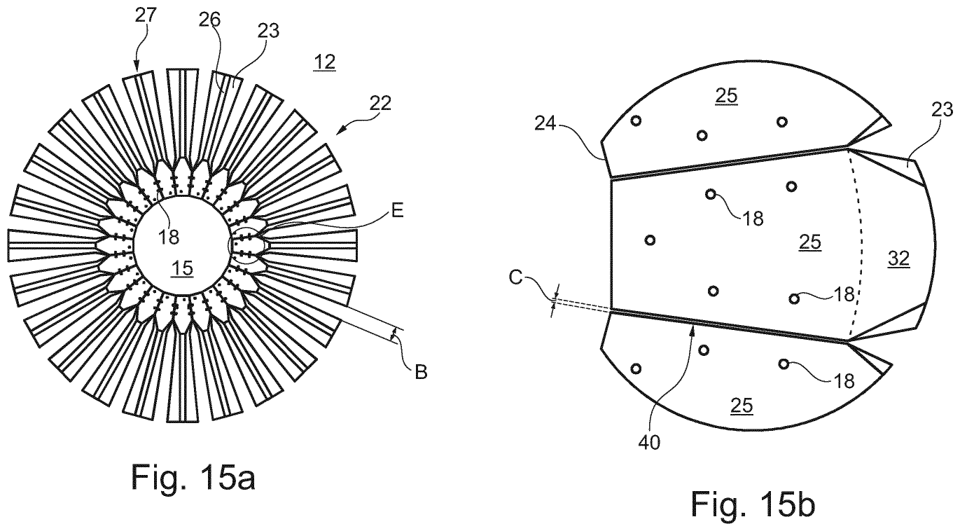

FIG. 15a a plan view of arranged surface elements of the foundation,

FIG. 15b a detailed view of FIG. 15a,

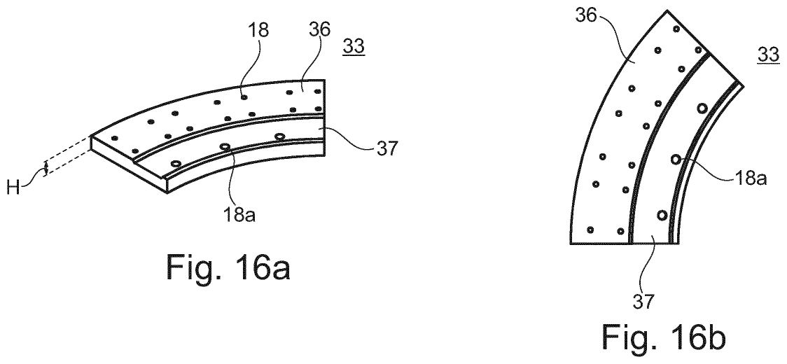

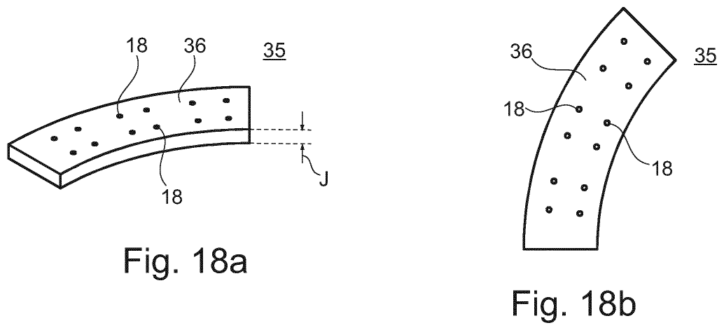

FIGS. 16a to 18b views of base segments in plan and as a spatial view,

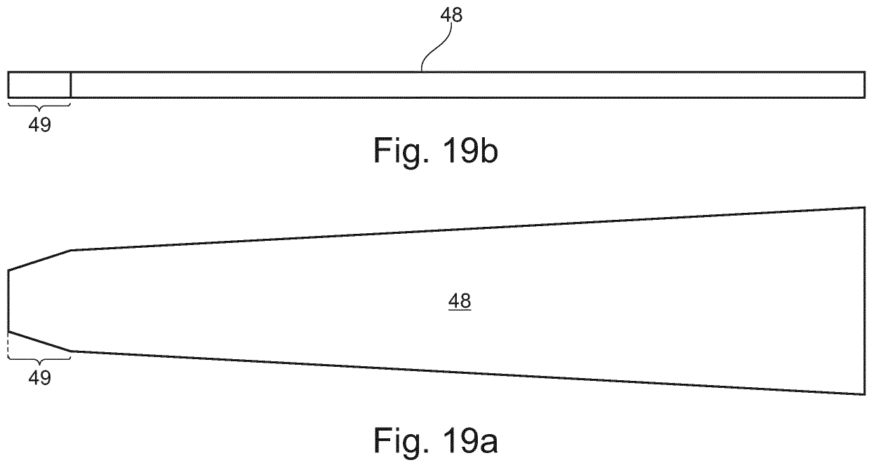

FIGS. 19a, 19b a top view and a side view of a cover plate according to the invention, and

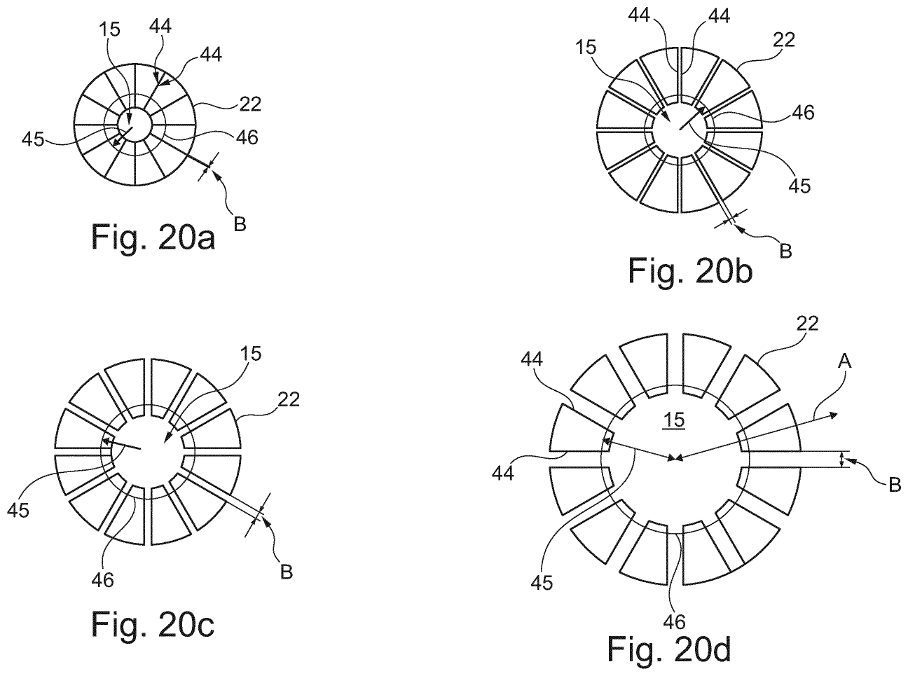

FIGS. 20a to 20d different arrangement options to FIG. 15a.

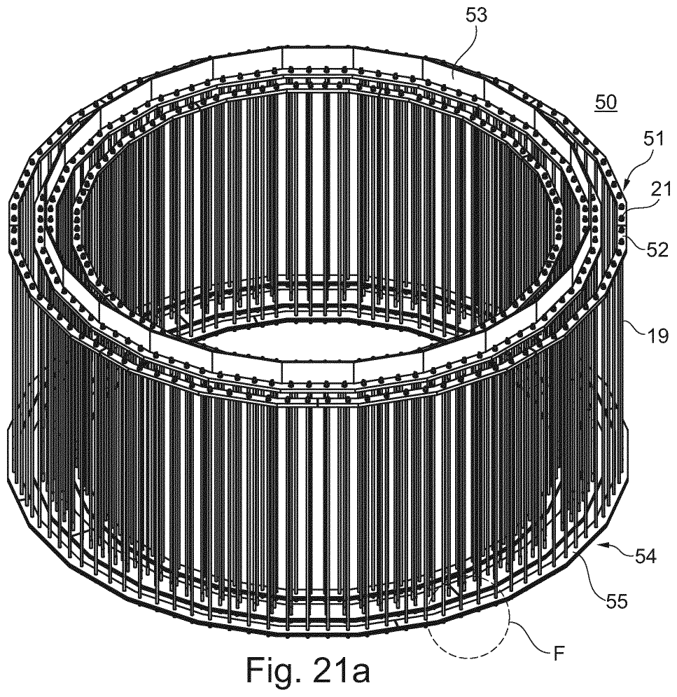

FIG. 21a a spatial view of an anchor cage according to the invention,

FIG. 21b a detailed view of FIG. 9a,

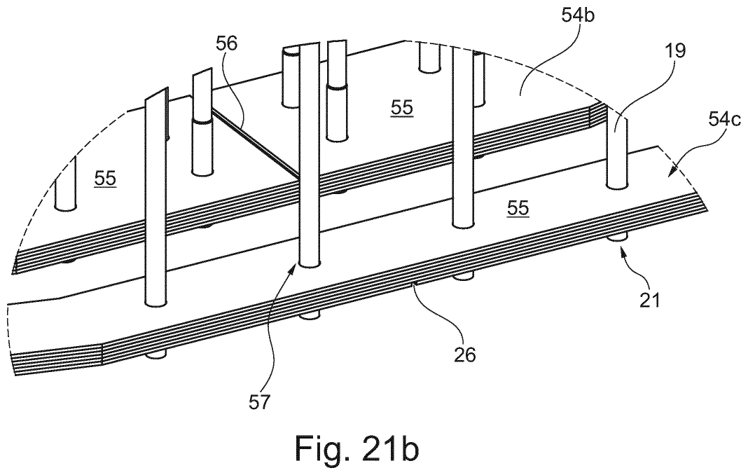

FIG. 22 a top view of an upper abutment ring of the anchor cage shown in FIG. 9a,

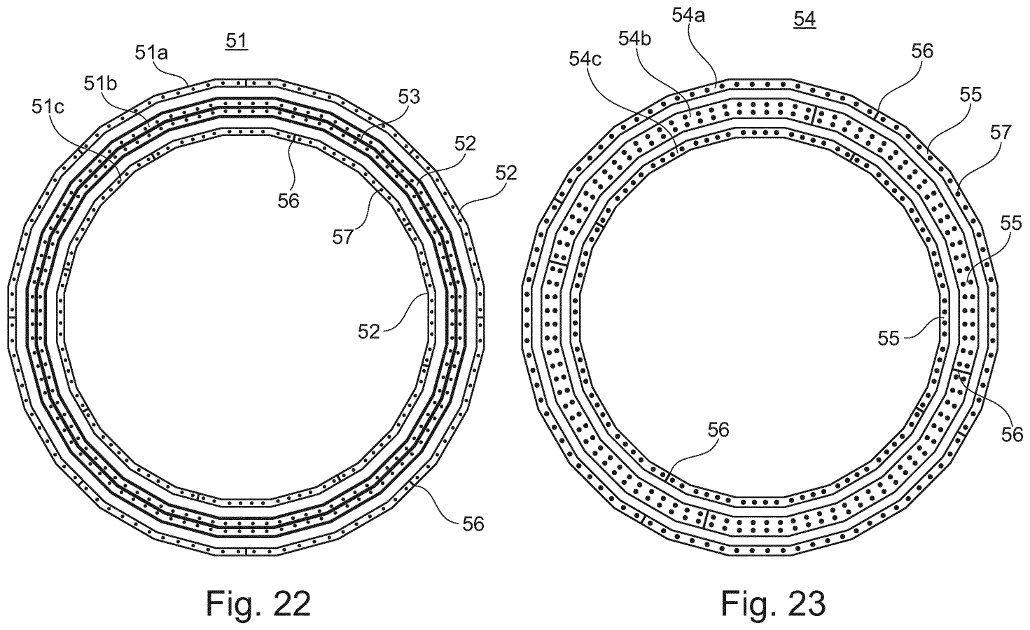

FIG. 23 a top view of a lower abutment ring of the anchor cage shown in FIG. 9a,

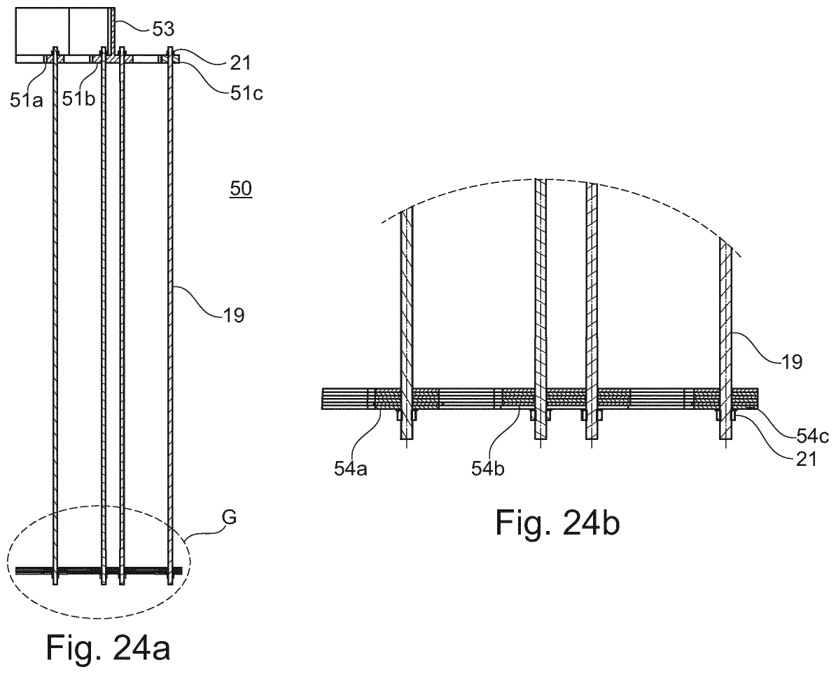

FIG. 24a a sectional view through the armature basket according to the invention as shown in FIG. 9a,

FIG. 24b a detailed view of FIG. 12a,

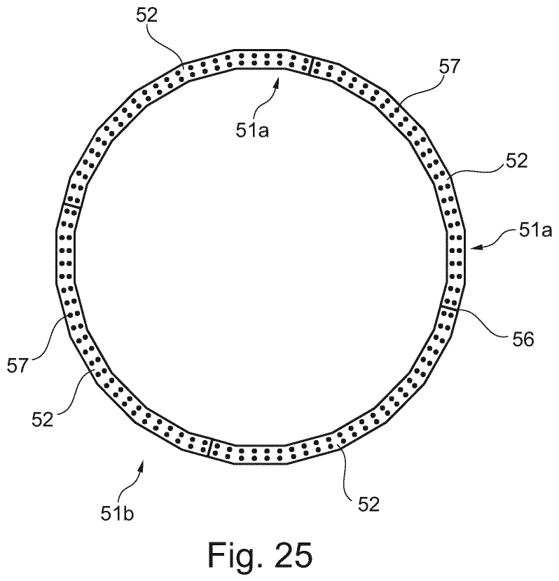

FIG. 25 a top view of an upper abutment ring according to the invention as an upper and/or lower connection for the tendons of the foundation according to the invention,

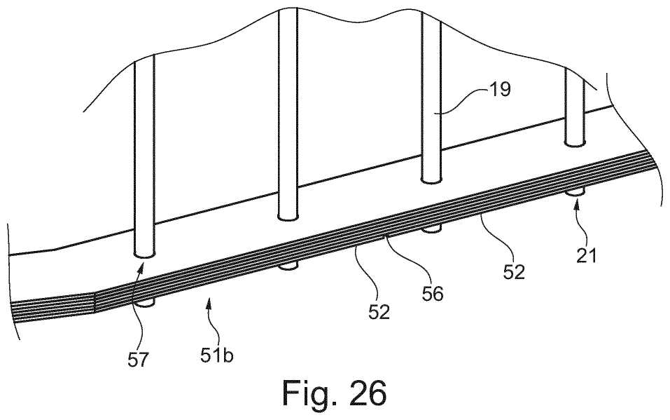

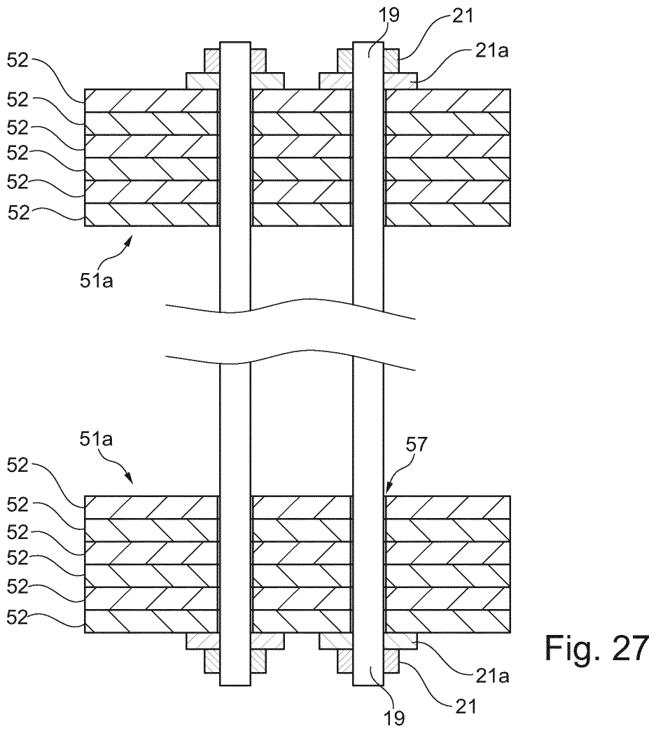

FIG. 26 an abstracted spatial detail view of FIG. 27,

FIG. 27 a sectional view through an embodiment of the upper and lower abutment ring according to FIG. 25 with mounted tendons,

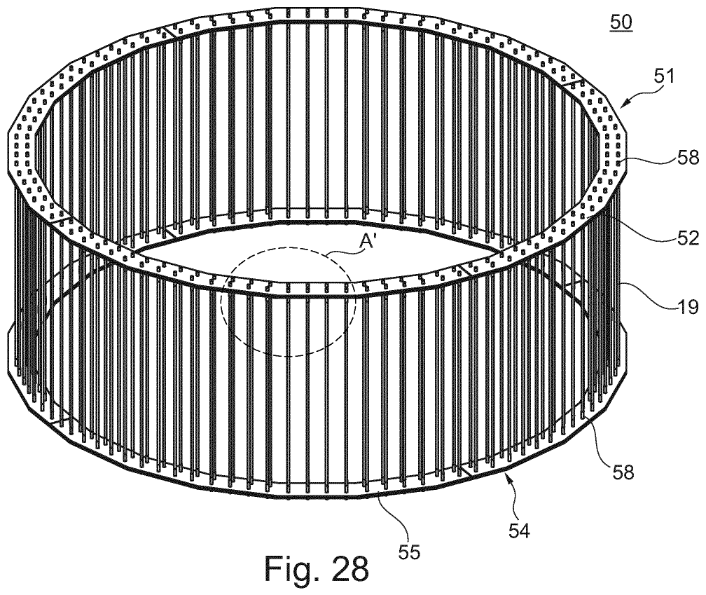

FIG. 28 a spatial view of a further embodiment of an anchor cage according to the invention,

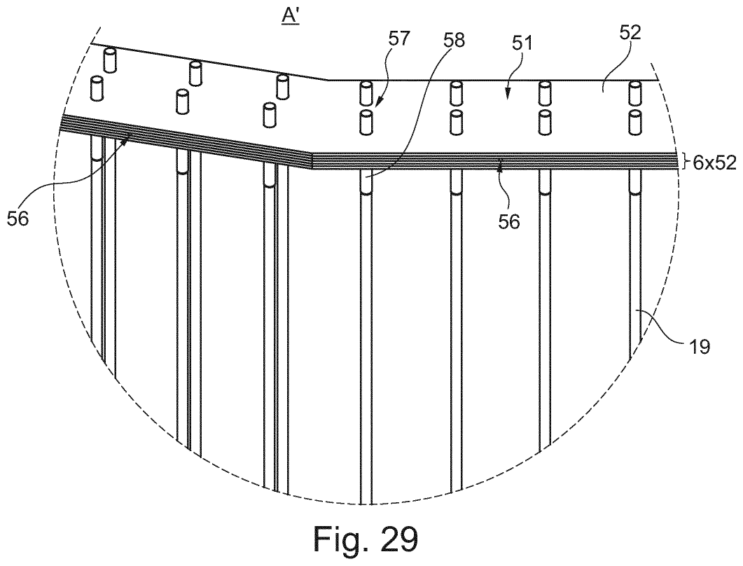

FIG. 29 an enlarged view of a section A′ to FIG. 28,

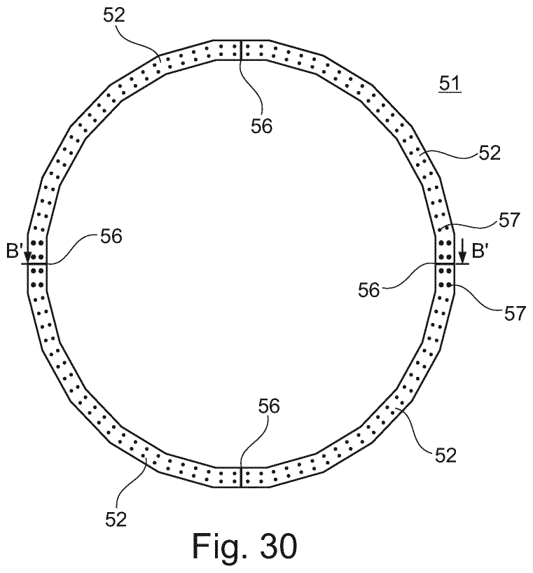

FIG. 30 a top view of FIG. 28,

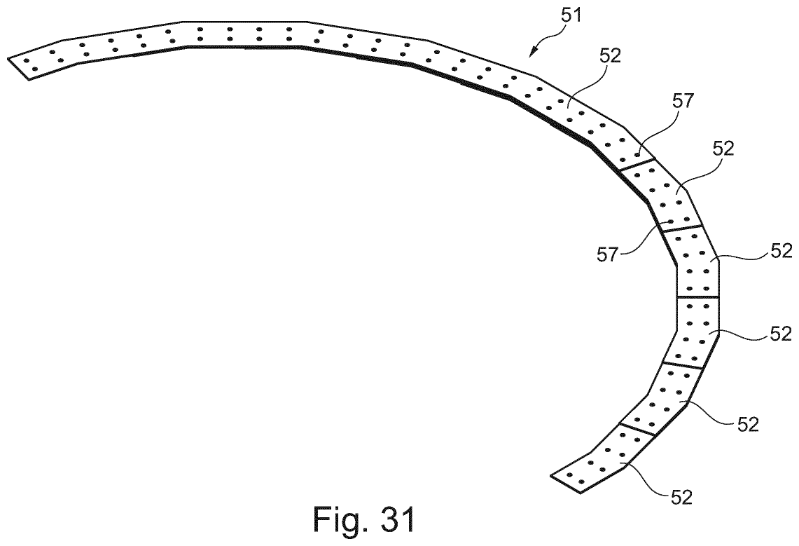

FIG. 31 a three-dimensional view of 5 layers of flange plates of the upper and/or lower abutment arranged in steps one above the other as shown in FIG. 28,

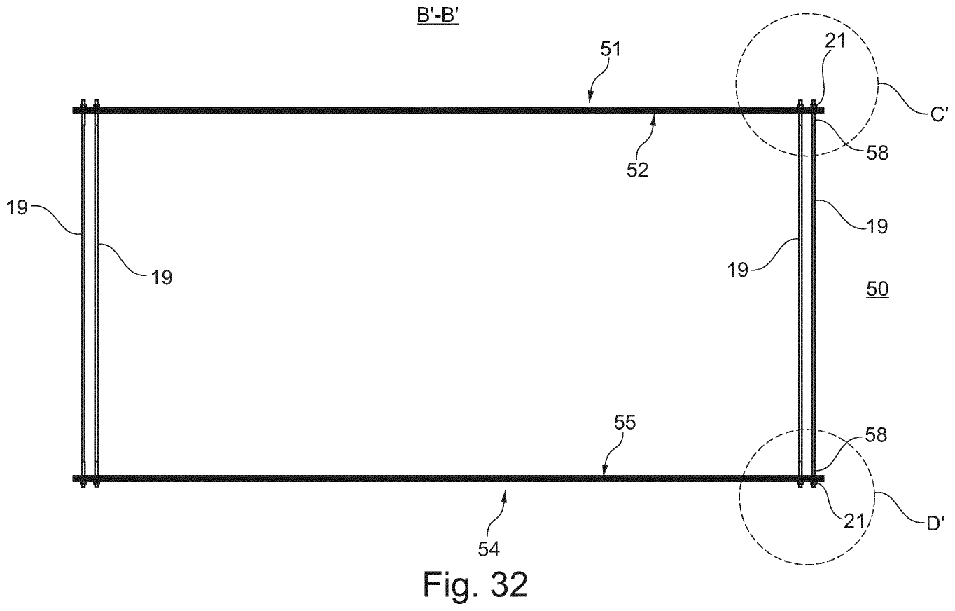

FIG. 32 a sectional view B′-B′ of FIG. 30,

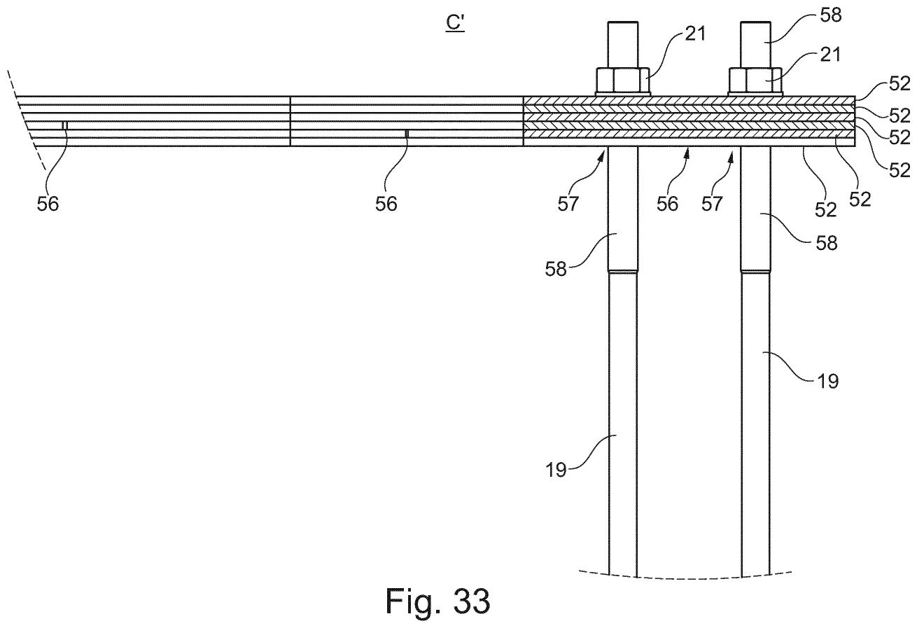

FIG. 33 an enlarged view of a section C′ of the upper abutment of FIG. 32, and

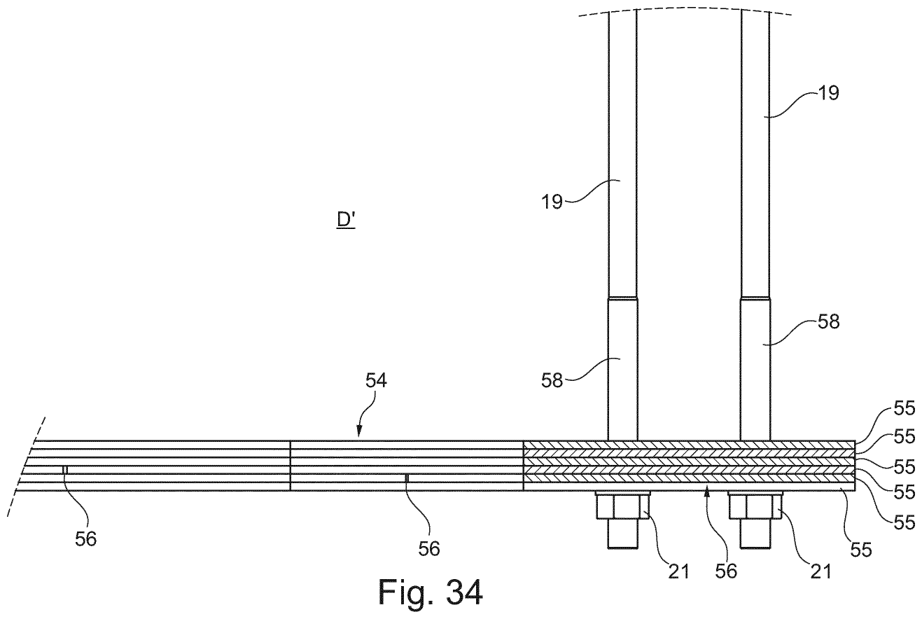

FIG. 34 an enlarged view of a section D′ of the lower abutment to FIG. 32.

In FIG. 1, a first embodiment of a foundation 10 is arranged in a sectional view in a pit 101 in the ground 100 possibly on a possibly compacted cleanliness layer 102. The foundation 10 has a first section 11 and a second section 12. Furthermore, a third section (not shown) may also optionally be provided under the second section 12, which is then preferably provided in a recess (not shown), if it should be necessary for structural reasons to extend the base 20 further into the ground.

The first section 11 is designed as a base 20, which is built up of several layers 13, 16, 17, wherein the layers 13, 16, 17 are built up of, for example, 5 layers 13a, 13b, 16a, 17a, 17b. If necessary, further layers can be provided.

The layers 13a, 13b, 16a, 17a, 17b are constructed from closed base sections 14, which in turn are constructed from individual base segments 33, 34, 35 (see FIGS. 6a to 8b). The base sections 14 are preferably designed here as circular rings, so that the base section 11 has an interior space 15. An alternative structure, e.g. a polygonal structure, is possible.

The layers 13, 16, 17 are preferably composed here of the individual layers 13a, 13b, 16a, 17a, 17b, the layers themselves being composed of base segments 33, 34, 35 matching the layers. The uppermost layer 13 has two layers 13a, 13b. The top layer 13a is composed of base segments 33, for example as shown in FIG. 6a, 6b, with a height H. The top side 36 of these base segments 33, 34, 35 has a height H. On their upper side 36, for example, three recesses 37 are provided here, into which an upper connecting flange 51 of an anchor cage 50, see FIGS. 21a to 24b, can be inserted. In the recesses 37, the openings 18 for the tendons 19 are provided.

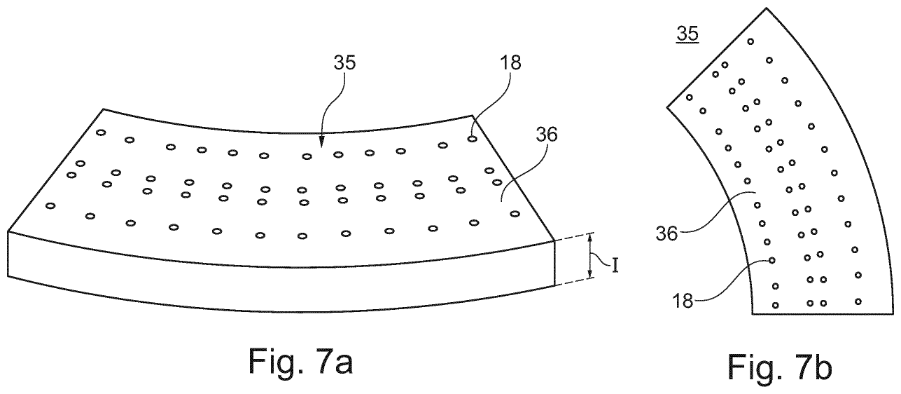

Below this, a layer 13b is provided, which is composed of base segments 35 (FIGS. 7a, 7b) with a height I, which are also provided with openings 18 for the tendons 19. The height I can be identical to the height H of the base segments 34 and is preferably the same.

Below this is the layer 16a as the middle layer 16, which is composed of base segments 34 with a height J. The base segments 34 are also provided with openings 18 for the tendons 19.

Provided below this is the lower layer 17 with layers 17a, 17b, which in turn are formed from base segments 34.

The base segments 33, 34, 35 are preferably very precisely designed with regard to the height H, I, J, i.e. with the smallest possible height deviations, in order to effect the largest possible contact surface of the base segments 33, 34, 35 on one another when they are mounted on top of one another to form the base 20 and are prestressed.

The height H, I of the base segments 33, 35 is designed in such a way that, when installed, it is essentially only loaded in tension/compression, i.e. it is subjected to a load in the normal direction. The reinforcement is also designed for this purpose (not shown), essentially comprising reinforcement in the normal direction. Preferably, the heights H and I are the same.

The height J of the base segments 34 is designed in such a way that it is essentially only loaded in shear when installed. The reinforcement is also designed for this purpose (not shown), essentially comprising reinforcement in the radial direction, particularly preferably in the form of stirrups.

The arrangement of segments 33, 34, 35 to form ring-like layers 13a, 13b, 16a, 17a, 17b and the arrangement layers 13a, 13b, 16a, 17a, 17b one above the other to form layers 13, 16, 17, which then form the base, is shown spatially in FIG. 2. The base segments 33, 34, 35 are provided butted next to each other so that vertical gaps 38 exist between them. These are preferably designed as gaps, for example, with a thickness of several millimeters, e.g. 30 mm. These vertical joints 38 are preferably not filled with mortar or in-situ concrete. Furthermore, preferably no horizontal connecting means are provided.

Furthermore, the vertical joints of the individual layers 13a, 13b, 16a, 17a, 17b are preferably provided such that the vertical joints 38 of adjacent layers 13a, 13b, 16a, 17a, 17b are not aligned, i.e. are not arranged one above the other. As shown in FIG. 2, it is advantageous if the vertical joints 38 are always arranged offset clockwise or counterclockwise by substantially the same value.

Horizontal joints 39 exist between layers 13a, 13b, 16a, 17a, 17b and are preferably not filled with mortar or cast-in-place concrete.

The base segments 33, 34, 35 have vertical apertures 18 in which tendons 19, for example anchor rods or reinforcement rods 19 with counter elements such as nuts 21, are provided to pretension the foundation 10 during assembly. These, together with abutments 51, 54 composed of flange plates 52, 55, form an anchor cage 50. Part of the upper abutment 51 may also be the connection adapter 53 for the tower, for example if the tower is a steel tower.

The second section 12 is flat. Alternatively, however, it can also be implemented in a star shape. A top view of the foundation 10 is shown in FIG. 3. FIG. 2 shows a spatial view of the foundation 10. The second section 12 is made of horizontal elements 22 in the form of rib elements. These are shown in FIGS. 4a to 4e. These extend radially outward as viewed from the interior 15.

They have a base plate 23 that is trapezoidal in shape, for example, so that all assembled base plates form a polygonal surface (see FIGS. 3, 5a) that approximates a circular shape. Alternatively, circular segments or a mixed form of circular segment and trapezoidal shape are also possible. Spaces B can preferably be provided between side walls 44 of the base plates 23, which are dependent on the diameter of the tower to be erected.

At the inner end 24 of the base plate 23, a support section 25 is provided with a body and side walls 29 that substantially preferably corresponds to the base 20 of the first section 11. Apertures 18 may also be provided in the support section 25. Alternatively, reinforcing bars or anchor rods 19 may be installed in the support section 25 in alignment with the apertures 18 in the first section 11 and extend outwardly from the concrete of the pedestal-like section 25 of the horizontal member 22. The base 20 with its at least one base element 14 is arranged on the support section 25.

Perpendicular to the base plate is the stiffening wall 26, the height of which decreases, for example, towards the outer end 27 of the base plate 23.

The base plate 23 is parallel tapered with respect to the side surfaces 29 of the body 30 of the support section 25. The parallel taper 31 is shown by the arrow D in FIG. 4c. This preferably achieves a reduction in material. The body 30 has a transition region 32 with which the stiffening wall 26 is connected to the support section 25 in a reinforcing manner.

Between the side surfaces 29 of the support sections 25, as shown in FIG. 5b as section E to FIG. 5a, a distance C is preferably provided as a vertical joint 40 when the horizontal elements 22 are arranged, which is preferably designed as an air gap. This results in vertical joints 40, which are also preferably not filled with mortar or in-situ concrete. Furthermore, preferably no horizontal connecting means are provided.

An upwardly open cavity 28 is formed between two adjacent stiffening walls 26, into which backfill soil 104 can be placed, thereby providing a surcharge load on the second section 12 of the foundation 10.

To allow the cavities 28 to be filled with backfill soil 104 and to prevent it from entering the interior 15, barrier elements (not shown) can be placed against the body 30 of the support section 25 or transition area 32.

Furthermore, cover plates 48 (FIGS. 9a, 9b) are provided to be placed on two adjacent base plates 23 to cover the gap B between two side surfaces 44 to prevent the backfill soil 104 from entering or passing through the gap B. The cover plates 48 have a tapered section 49 that is adapted to the transition area 32. The cover plate 48 allows the full ballast load of the backfill soil 104 to be applied to the second section 12 by insertion into the cavity 28.

The interior space 15 may be backfilled with backfill soil 104 and covered with a cover element 103 after the foundation 10 is completed.

As shown in FIGS. 10a to 10d, it is possible to form a second section with a horizontal element 22 that has differently sized interior spaces 15 by moving the horizontal elements 22 inward or outward along a ray extending from the center point, as shown by the double arrow A in FIG. 19d. Inwardly, this is limited by the fact that the side surfaces 44 of the base plates 23 of the horizontal elements 22 are in contact. Outwardly, this depends on the radius 45 of the tower to be erected, which is shown by a circle 46 in FIGS. 14a to 14d. The gap B is preferably the same over the entire length of the side surfaces 44 from the inner end 24 to the outer end 27, so that two side surfaces 44 are arranged parallel to each other. Through this, foundations for towers with different diameters can be erected in a simple manner preferably with a single horizontal element 22.

For providing the necessary bracing between the layers 13, 16, 17 of the first section and the horizontal elements 22 of the second section 12, an anchor cage 50 is formed as a first embodiment of an anchor cage according to the invention, as shown in FIGS. 21a to 24b, which is formed by an upper and a lower abutment 51, 54, shown in FIG. 22 and FIG. 23, which are connected to tendons 19, for example in the form of anchor rods or reinforcement rods, and counter elements 21, for example nuts.

The upper and lower abutment elements 51, 54 are composed, for example, of three concentric abutment rings 51a, 51b, 51c, 54a, 54b, 54c, of which the middle abutment ring 51b preferably contains the connection adapter 53 for the tower of the wind turbine. The abutment rings 51a, 51b, 51c, 54a, 54b, 54c can be provided from individual flange plates 52, 55, which are arranged butted together, as this is shown in FIG. 3, FIG. 21b as section F to FIG. 21 and FIG. 24b as section G to FIG. 24a. Furthermore, several flange plates 52, 55 can also be arranged one above the other. In this case, these are then preferably arranged in such a way that their vertical joints 56 do not overlap in adjacent layers of the flange plates 52, 55. Preferably, the flange plates 52, 55 are not welded to each other, but lie on or against each other. The flange plates 52, 55 have apertures 57 and can be provided with different widths and different numbers of rows of apertures 57 per flange plate 52, 55.

Preferably, the abutment ring 51b may be integral with the connection adapter 53 as a flange plate 52.

In FIG. 11, a second embodiment of a foundation 10 is arranged in sectional view in a pit 101 in the ground 100, possibly on a possibly compacted cleanliness layer 102. The foundation 10 thereby has a first section 11, which is arranged on a second section 12. Furthermore, a third section 12a is provided below the second section 12, which is provided in a depression 105 of the excavation 101.

The three sections 11, 12, 12a form a base 20, which in turn is constructed from several layers 13, 16, 17, the layers 13, 16, 17 being constructed here, for example, from 5 layers 13a, 13b, 16a, 17a, 17b. If necessary, further layers can be provided.

The layers 13a, 13b, 17a, 17b are constructed from closed base sections 14, which in turn are constructed from individual base segments 33, 34, 35 (see FIGS. 16a to 18b). The base sections 14 are preferably designed here as circular rings, so that the base section 11 has an interior space 15. An alternative structure, for example a polygonal structure, is possible.

The layers 13, 16, 17 are preferably composed here of the individual layers 13a, 13b, 16a, 17a, 17b, the layers 13a, 13b, 17a, 17b themselves being composed of base segments 33, 34, 35 matching the layers. The uppermost layer 13 has two layers 13a, 13b. The top layer 13a is composed of base segments 33, for example as shown in FIGS. 16a, 16b, with a height H. The top side 36 of the base segments 33, 34, 35 is shown here, for example, as shown in FIGS. 16a, 16b. On their upper side 36, for example, a recess 37 is provided here, in which a connecting flange for the tower of the wind turbine or directly the lowest segment of the tower of the wind turbine is placed (not shown). In the recesses 37, the apertures 18a for tendons (not shown of the ‘tower of the wind turbine are provided. Furthermore, apertures 18 are provided for tendons 19. In the area of the apertures 18, abutment flanges 51, for example as shown in FIG. 25, are arranged on the upper side 36, against which the tendons 19 are braced via the counter elements 21.

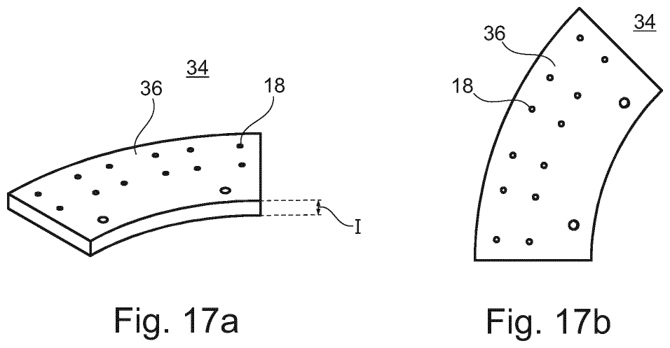

Below this, a layer 13b is provided, which is composed of base segments 34 (FIGS. 17a, 17b) with a height I, which are also provided with apertures 18 for the tendons 19 and apertures 18a. The height I can be identical to the height H of the base segments 33 and is preferably the same.

Below this is the layer 16a as the middle layer 16. This is formed by the bodies 30 of the support sections 25 of the horizontal segments 22. These have the height K. The bodies 30 are also provided with openings 18 for the tendons 19.

Provided below this, and thus below the horizontal elements 22, is the lower layer 17 with the layers 17a, 17b, which are formed from base segments 35 with a height J. The base segments 35 are also provided with apertures 18 for the tendons 19. The base segments 35 are also provided with openings 18 for the tendons 19.

The base segments 33, 34, 35 and the body 30 of the horizontal element 22 are preferably very precisely designed with respect to the height H, I, J, K, i.e. with the smallest possible height deviations, in order to bring about the largest possible contact surface of the base segments 33, 34, 35 and the body 30 on one another when these are mounted on top of one another to form the base 20 and are prestressed.

The height H, I, J of the base segments 33, 35 is designed in such a way that, in the installed state, it is essentially only loaded in tension/compression, i.e. it is subjected to a load in the normal direction. The reinforcement is also designed for this purpose (not shown), essentially comprising reinforcement in the normal direction. Preferably, the heights H, I and J are the same.

The height K of the bodies 30 is designed in such a way that, in the installed state, it is essentially only loaded in shear. The reinforcement can also be designed for this (not shown), which essentially comprises reinforcement in the radial direction, particularly preferably in the form of stirrups.

The arrangement of segments 33, 34, 35 and body 30 to form ring-like layers 13a, 13b, 16a, 17a, 17b and the arrangement layers 13a, 13b, 16a, 17a, 17b one above the other to form layers 13, 16, 17, which then form base 20, is shown spatially in FIG. 12. The base segments 33, 34, 35 and the bodies 30 are provided butted side by side so that vertical gaps 38, 40 exist between them. These are preferably designed as gaps, for example, with a thickness of several millimeters, e.g. 30 mm. These vertical joints 38, 40 are preferably not filled with mortar or in-situ concrete. Furthermore, preferably no horizontal connecting means are provided.

Furthermore, the vertical joints of the individual layers 13a, 13b, 16a, 17a, 17b are preferably provided such that the vertical joints 38, 40 of adjacent layers 13a, 13b, 16a, 17a, 17b are not aligned, i.e. are not arranged one above the other. As shown in FIG. 12, it is advantageous if the vertical joints 38 are always arranged offset by substantially the same value clockwise or counterclockwise.

Horizontal joints 39 exist between layers 13a, 13b, 16a, 17a, 17b and are preferably not filled with mortar or in-situ concrete.

The base segments 33, 34, 35 and the bodies 30 have vertical apertures 18 in which tendons 19, for example anchor rods or reinforcement rods 19 with counter elements such as nuts 21 in conjunction with washers 21a are provided to pretension the foundation 10 when the foundation 10 is assembled. These, together with abutments 51a composed of flange plates 52, form an anchor cage (not shown). Part of the upper abutment 51a can also be the connection adapter 53 for the tower, for example if the tower is a steel tower.

The second section 12 is flat. Alternatively, however, it can also be implemented in a star shape. A top view of the foundation 10 is shown in FIG. 13. FIG. 12 shows a spatial view of the foundation 10. The second section 12 is made of horizontal elements 22 in the form of rib elements. These are shown in FIGS. 14a to 14e. These extend radially outward as viewed from the interior 15.

They have a base plate 23 which is, for example, trapezoidal in shape so that all the assembled base plates form a polygonal surface (see FIG. 13, 5a) which approximates a circular shape. Alternatively, circular segments or a mixed form of circular segment and trapezoidal shape are also possible. Spaces B can preferably be provided between side walls 44 of the base plates 23, which are dependent on the diameter of the tower to be erected.

At the inner end 24 of the base plate 23, a support section 25 is provided having a body and sidewalls 29 that substantially preferably corresponds to the base 20 of the first section 11. Apertures 18 may also be provided in the support section 25. Alternatively, reinforcing bars or anchor rods 19 may be installed in the support section 25 in alignment with the apertures 18 in the first section 11 and extending outwardly from the concrete of the pedestal-like section 25 of the horizontal member 22. The base 20 with its at least one base element 14 is arranged on the support section 25.

If a tower is erected by means of pretensioning elements (not shown) and tensioned accordingly, then, as shown here, it is advantageous to provide a recess 30a in the body 30 in order to check the counter elements of the tower pretensioning and to retension them if necessary. The apertures 18a thereby preferably open into the area of the recess, as this is shown here. Furthermore, the apertures 18a are preferably provided at an incline so that the tower pretensioning elements can be passed directly therethrough.

Perpendicular to the base plate is the stiffening wall 26, the height of which decreases, for example, towards the outer end 27 of the base plate 23.

The base plate 23 is parallel tapered with respect to the side surfaces 29 of the body 30 of the support section 25. The parallel taper 31 is shown by the arrow D in FIG. 14c. This preferably achieves a reduction in material. The body 30 has a transition area 32 with which the stiffening wall 26 is connected to the support section 25 in a reinforcing manner.

Between the side surfaces 29 of the support sections 25, as shown in FIG. 5b as section E to FIG. 15a, a distance C is preferably provided as a vertical joint 40 when the horizontal elements 22 are arranged, which is preferably designed as an air gap. This results in vertical joints 40, which are also preferably not filled with mortar or in-situ concrete. Furthermore, preferably no horizontal connecting means are provided.

An upwardly open cavity 28 is formed between two adjacent stiffening walls 26, into which backfill soil 104 can be placed, thereby providing a surcharge load on the second section 12 of the foundation 10.

To allow the cavities 28 to be filled with backfill soil 104 and to prevent it from entering the interior 15, barrier elements (not shown) can be placed against the body 30 of the support section 25 or transition area 32.

Furthermore, cover plates 48 (FIGS. 9a, 9b) are provided which are placed on two adjacent base plates 23 to cover the gap B between two side surfaces 44 so that the backfill soil 104 cannot enter or pass through the gap B. The cover plates 48 have a tapered portion 49 that is adapted to fit the transition area 32. The cover plate 48 allows the full ballast load of the backfill soil 104 to be applied to the second section 12 by insertion into the cavity 28.

The interior space 15 may be backfilled with backfill soil 104 after completion of the foundation 10 and covered with a cover element (not shown).

As shown in FIGS. 10a to 10d, it is possible to form a second section with a horizontal element 22 that has differently sized interior spaces 15 by moving the horizontal elements 22 inward or outward along a ray extending from the center point, as shown by the double arrow A in FIG. 10d. Inwardly, this is limited by the fact that the side surfaces 44 of the base plates 23 of the horizontal elements 22 are in contact. Outwardly, this depends on the radius 45 of the tower to be erected, which is shown by a circle 46 in FIGS. 10a to 10d. The gap B is preferably the same over the entire length of the side surfaces 44 from the inner end 24 to the outer end 27, so that two side surfaces 44 are arranged parallel to each other. Through this, foundations for towers with different diameters can be erected in a simple manner preferably with a single horizontal element 22.

For providing the necessary bracing between the layers 13, 16, 17 of the first, second and third sections 11, 12, 12a, an anchor cage is formed as a second embodiment of an anchor cage according to the invention, which is formed by an upper and a lower abutment 51a shown in FIG. 25, which are connected to tendons 19, for example in the form of anchor rods or reinforcement bars, and counter elements 21, for example nuts.

The upper and lower abutment elements 51a are composed, for example, of an abutment ring 51b. The abutment ring 51b can be provided from individual flange plates 52, which are arranged butted against each other, as shown in FIG. 26 as an indicated armature basket section. Furthermore, several flange plates 52 can be arranged on top of each other, as shown in FIG. 26 and FIG. 27. In this case, these are then preferably arranged in such a way that their vertical joints 56 do not overlap in adjacent layers of the flange plates 52. Preferably, the flange plates 52 are not welded to each other, but rest on or against each other. The flange plates 52 have apertures 57 and can be provided with different widths and different numbers of rows of apertures 57 per flange plate 52, 55.

Preferably, the abutment ring 51b may be integral with the connection adapter 53 as a flange plate 52.

FIGS. 28 to 34 show a further embodiment of an anchor cage 50 according to the invention, such as can be used in one of the embodiments of the foundation 10.

The anchor cage 50 has an upper abutment 51 and a lower abutment 54, which are connected by connecting means here preferably in the form of anchor rods 19 as tensioning elements. The anchor rods 19 here preferably have a threaded section 58 on both sides, onto which tensioning elements in the form of nuts 21 can be screwed in order to introduce a prestress into the anchor rods 19 and at the same time to brace the abutments 51, 54 against the elements of the foundation 10, here preferably the base elements and the surface elements/rib elements, or to brace them together.

The upper abutment 51 is preferably composed of 6 abutment segments arranged one above the other, preferably in the form of abutment rings, each of which is preferably composed of 4 abutment elements, preferably in the form of flange plates 52. Other arrangements and numbers are possible.

The lower abutment 54 is here preferably composed of 6 abutment segments arranged one above the other, here preferably in the form of abutment rings, which are each here preferably composed of 4 abutment elements, here preferably in the form of flange plates 55. Other arrangements and numbers are possible.

The flange plates 52 and flange plates 55 of an abutment segment, which are arranged on one plane, are butted so that there are joints 56 between the flange plates, as shown in FIGS. 29, 30, 33, 34.

These are then preferably arranged so that their vertical joints 56 do not overlap in adjacent layers of the flange plates 52. The offset of the flange plates 52, 55 to achieve this is shown in FIG. 31 as an example for the upper abutment 51 and its flanges 52. This can also apply to the lower abutment 54 and its flange plates 55.

Preferably, the flange plates 52 are not welded to each other, but rest on or against each other. The flange plates 52 have apertures 57 and can be provided with different widths and different numbers of rows of apertures 57 per flange plate 52, 55.

The anchor rods 19 are located in the apertures 57 in the flange plates 52, 55.

The design of the abutments 51, 54 can be varied as required for the anchor cage 50. For example, only the upper abutment 51 can have the structure described above or only the lower abutment 54.

Furthermore, several such abutment rings can also be provided concentrically in this embodiment of the anchor cage, analogous to, for example, FIG. 22 or FIG. 23.

Furthermore, it is also possible to integrate a connection adapter 53.

List of reference signs

| | |
|---|---|
| 10 | foundation |
| 11 | first section |
| 12 | second section |
| 13 | upper layer |
| 13a | layer |
| 13b | layer |
| 14 | base section |
| 15 | Interior space |
| 16 | middle layer |
| 16a | layer |
| 17 | lower layer |
| 17a | layer |
| 17b | layer |
| 18 | opening |
| 19 | tendon/anchor rods |
| 20 | socket |
| 21 | counter element/nut |
| 22 | horizontal element/rib element |
| 23 | base plate |
| 24 | inner end |
| 25 | bearing section |
| 26 | stiffening wall |
| 27 | external end |
| 28 | cavity |
| 29 | side wall |
| 30 | body |
| 30a | Recess |
| 31 | parallel taper |
| 32 | transition area |
| 33 | upper base segment |
| 34 | middle base segment |
| 35 | base segment |
| 36 | top side |
| 37 | recess |
| 38 | vertical joint |
| 39 | horizontal joint |
| 40 | vertical joint |
| 44 | side wall |
| 45 | radius |
| 46 | circle |
| 48 | cover plate |
| 49 | tapered section |
| 50 | anchor cage |
| 51 | top abutment |
| 51a | Bearings |
| 51b | Bearing ring |
| 52 | Flange plate |
| 53 | Connection adapter |
| 54 | lower abutment |
| 55 | flange plate |
| 56 | vertical joint |
| 57 | aperture |
| 58 | Thread section |
| 100 | ground |
| 101 | pit |
| 102 | cleanliness layer |
| 103 | cover element |
| 104 | backfill soil |
| 105 | depression |
| A | Shift direction |
| B | gap |
| C | distance |
| D | arrow of the parallel taper |
| E | detailed view |
| F | detailed view |
| G | detailed view |
| H | height |
| I | height |
| J | height |
| K | height |

1-31. (canceled)

32. An anchor cage for a foundation of a wind turbine, comprising
at least one lower abutment,
at least one upper abutment,
at least one vertical connecting element between the at least one lower abutment and the at least one upper abutment,
at least one element for introducing a prestress into the at least one vertical connecting element,
wherein at least one of the at least one lower abutment or the at least one upper abutment is formed from at least two abutment segments one above the other, and wherein at least one of the two abutment segments comprises at least two abutment elements.

33. The anchor cage according to claim 32, wherein at least one of the at least one upper or the at least one lower abutment are a closed annular shape, including one of a circular ring or as a polygon.

34. The anchor cage according to claim 32, wherein the at least two abutment elements are butted together on one plane.

35. The anchor cage according to claim 33, further comprising joints between the butted abutment elements.

36. The anchor cage according to claim 32, comprising at least two abutment segments, one above the other, both formed from at least two abutment elements.

37. The anchor cage according to claim 36, wherein joints between the at least two abutment segments do not to overlap.

38. The anchor cage according to claim 32, wherein the abutment elements comprise at least one aperture for the at least one vertical connecting element.
